(19) United States
(12) Patent Application Publication
(10) Pub. No.: US 2019/0226186 A1
(43) Pub. Date: Jul. 25, 2019

(54) INJECTION-MOLDED FAUCET BODY AND METHOD FOR MANUFACTURING SAME

(71) Applicant: Kyungmi PARK, Gyeonggi-do (KR)

(72) Inventor: Kyungmi PARK, Gyeonggi-do (KR)

(21) Appl. No.: 16/338,657

(22) PCT Filed: Apr. 10, 2017
(86) PCT No.: PCT/KR2017/003866

§ 371 Date: Apr. 1, 2019

(30) Foreign Application Priority Data
Nov. 11, 2016 (KR) 10-2016-0150456

(51) Int. Cl. E03C 1/04; B29C 45/00

(52) U.S. Cl. CPC E03C 1/04; B29K 2055/02; B29C 45/0053; B29C 45/0001

(57) ABSTRACT

The present invention provides an injection-molded faucet body and a method for manufacturing the same. The faucet body includes a plastic housing constituting the outer layer thereof and a plastic inner core constituting the inner layer thereof. When the plastic inner core, among the same, is injection-molded using double plastic injection molding, a valve spool mounting groove, a cold water supply opening, a warm water supply opening, a cold water supply tank, a warm water supply tank, and a water discharge tank are formed. In addition, sealing cover plates are installed in the cold water supply tank, the warm water supply tank, and the water discharge tank such that a cold water supply cavity, a warm water supply cavity, and a water discharge cavity are formed therein, respectively. The plastic housing is formed by performing secondary injection coating with regard to the plastic inner core.

### TECHNICAL FIELD

The present invention relates to a faucet, and more particularly to an injection-molded faucet body and a method for manufacturing the same.

### BACKGROUND ART

In general, conventional faucets may be divided into a faucet formed of stainless steel, a faucet formed of cast iron, a faucet formed of full plastic, a faucet formed of brass and a faucet formed of a zinc alloy, and a faucet formed of metal requires a cumbersome manufacturing process and has comparatively high production costs. A plastic faucet is difficult to manufacture into a curved water pipe or a water pipe having an irregular shape and is used only to manufacture into a straight-type water pipe. Therefore, a conventional full plastic faucet body is formed by respectively forming a plurality of members by plastic molding and then assembling the respective members and may thus solve a problem of unification of design of water current paths, but such a faucet body may have poor stability, rupture and cause water leakage when water pressure is applied thereto for a long time, and influence use of a product.

The related art discloses a faucet and a method for manufacturing the same, in which respective parts of a faucet body are divisionally formed by molding using brass, particularly, a reference body provided with a valve installed therein, a first assembly provided with a warm water inlet formed therein, a second assembly provided with a cold water inlet formed therein, and a third assembly provided with a water outlet formed therein are divisionally formed by molding; inner molded assemblies are respectively formed in the first to third assemblies so as to have flow paths and connection assembly parts by double injection molding using a polyamide-based resin composition; the first to third assemblies are bonded to the reference body; and, in order to reinforce and shield the bonding parts of the faucet body, the outer surface of the faucet body is plated with nickel-chrome.

Additional related art discloses a method for manufacturing a faucet body in which a reference body and first and second assemblies are formed by injection molding using a mixed material of ABS resin and glass fiber and an external molded body is formed at the exterior thereof by double injection molding using a single ABS resin composition.

Other related art discloses a method for manufacturing a faucet including cold and warm water flow path pipes, along which cold water, warm water and mixed water flow, are formed of polypropylene (PP) or polyethylene (PE) resin which are harmless to humans, and a body formed of ABS resin, in which metal parts and nonmetal parts for manufacturing the faucet are prepared, the cold and warm water flow path pipes are coupled to a manifold, and double injection molding using ABS resin is performed on the exterior of the manifold.

The faucets of the related art have problems in that the faucets still use metal materials, have difficulty in forming inner bodies thereof due to complexity of division structures of the inner bodies thereof, and have incomplete and unsound bonding structures of the divided inner bodies thereof, and have possibility of leaking drinking water through the glass fiber due to long-term use.

### Technical Problem

Therefore, the present invention has been made in view of the above problems, and it is an object of the present invention to provide an injection-molded faucet body which is of practical use and safe and can be mass-produced at a low price, and a method for manufacturing the same.

### Technical Solution

In order to implement the above and other objects, the present invention employs technologies described below.

In accordance with an aspect of the present invention, the above and other objects can be accomplished by the provision of an injection-molded faucet body including a plastic housing constituting an outer layer thereof and a plastic inner core constituting an inner layer thereof, wherein a valve spool mounting groove, a cold water supply opening, a warm water supply opening, a cold water supply tank, a warm water supply tank and a water discharge tank are formed in the plastic inner core, sealing cover plates matching respective tank bodies of the cold water supply tank, the warm water supply tank and the water discharge tank are installed such that a cold water supply cavity, a warm water supply cavity and a water discharge cavity are formed therein, a water discharge opening is formed through the sealing cover plate on the water discharge tank, the cold water supply opening communicates with the valve spool mounting groove through the cold water supply cavity, the warm water supply opening communicates with the valve spool mounting groove through the warm water supply cavity, the valve spool mounting groove communicates with the water discharge opening through the water discharge cavity, and, after the plastic housing are injection-molded integrally with the plastic inner core, through holes respectively corresponding to the valve spool mounting groove, the cold water supply opening, the warm water supply opening and the water discharge opening are formed through the plastic housing.

A slow current structure and a water supply hole communicating with the valve spool mounting groove may be formed in each of the cold water supply tank and the warm water supply tank, the slow current structure may include a first protrusion installed at a bottom of the tank body, the water supply hole in the cold water supply tank and the water supply hole in the warm water supply tank may be formed in the upper surfaces of the corresponding first protrusions, and, since the first protrusion serves to reduce a flow velocity of a water current and thus reduce pressure which water pressure applies to the plastic inner core, the water current may be more uniformly discharged from the water supply hole.

The slow current structure may further include a second protrusion installed at a side wall of the tank body, and the cold water supply opening and the warm water supply opening are formed in the corresponding second protrusions. That is, the first protrusions and the second protrusions may be installed perpendicularly to each other, and such a structure may allow water currents to flow into the corresponding water supply cavities along the cold and warm water supply openings and then change direction and be discharged through the corresponding water supply holes, thus being advantageous in mitigation of water current shock.

The tank body of the cold water supply tank may be formed so as to be gradually widened in a direction from the cold water supply opening to the water supply hole, and the tank body of the warm water supply tank may be formed so as to be gradually widened in a direction from the warm water supply opening to the water supply hole.

A water discharge joint configured to be connected to an external shower head and a grooved hole configured to mount a change-over switch to change water discharge between the water discharge opening and the water discharge joint may be further formed in the plastic inner core, and the grooved hole may be located at the water discharge tank.

In accordance with another aspect of the present invention, there is provided a method for manufacturing an injection-molded faucet body, the method including:

(1) forming a plastic inner core so as to integrally have a valve spool mounting groove, a cold water supply opening, a warm water supply opening, a cold water supply tank, a warm water supply tank and a water discharge tank, by injection molding;

(2) forming water current paths by covering the cold water supply tank, the warm water supply tank and the water discharge tank with sealing cover plates and forming a water discharge opening through the sealing cover plate on the water discharge tank, after forming the plastic inner core by injection molding; and

(3) forming a plastic housing constituting the outer layer of the faucet body through secondary injection coating performed by secondary injection molding of the plastic inner core, and thus forming a double plastic faucet body.

In the forming the plastic housing (3), a process of performing the secondary injection coating may include:

inserting fixing screws respectively into the cold water supply opening, the warm water supply opening and the water discharge opening of the plastic inner core such that the fixing screws are coupled to the plastic inner core to form a sealed body; and

forming the plastic housing on the surface of the plastic inner core by performing injection molding under the condition that the sealed body is placed in a plastic mold set.

In forming the plastic inner core by injection molding, a water discharge joint configured to be connected to an external shower head and a grooved hole configured to mount a change-over switch therein may be further formed, and, when the secondary injection coating is performed, the grooved hole may be sealed by inserting a fixing screw thereinto.

The method may further include (4) sequentially plating the plastic housing with a copper layer, a nickel layer and a chrome layer, after forming the plastic housing by secondary injection molding.

The plastic housing and the plastic inner core may be formed by injection molding using a mixture of ABS and PC, a mass percentage of ABS may be 20%-90%, a mass percentage of PC may be 10%-80%, the plastic housing and the plastic inner core may be injection-molded using the same material so that inner and outer plastic members are closely coupled to form an integral structure in the genuine sense and, in this manner, the structure of the faucet body may become more solid.

Further, ABS+PC may have high impact resistance, thermal resistance and hardness, good electroplating performance, and properties which are closer to metal, and a faucet formed of ABS+PC may be more highly durable and be more eco-friendlier than a faucet formed of metal. A mixed material of ABS resin and PC may have advantages on performances of both materials and cause cost reduction. In a PC/ABS mixture, PC (polycarbonate) may provide high thermal resistance, good toughness and impact strength, high strength and flame resistance, and ABS may enhance plasticity and appearance quality and decrease density. ABS+PC and the faucet formed thereof according to the present invention may completely comply with performance of a ceramic cartridge and heavy metal precipitation standards in GB18145-2014, hydraulic pressure resistance thereof may be much higher than 60S standards under a pressure of 2.5 MPa, there may be no zinc precipitation and, thus, use thereof may be safer.

### Advantageous Effects

The present invention has effects below: A faucet body in accordance with the present invention is formed using double plastic injection molding, when the plastic inner core, among the same, is injection-molded, a valve spool mounting groove, a cold water supply opening, a warm water supply opening, a cold water supply tank, a warm water supply tank and a water discharge tank are formed, sealing cover plates are respectively installed on the cold water supply tank, the warm water supply tank, and the water discharge tank such that a cold water supply cavity, a warm water supply cavity and a water discharge cavity are formed therein, and a structure in which the sealing cover plates are coupled to the integral plastic inner core may assure that a faucet more uniformly receives force, thus preventing quality problems, such as cracks, rupture and water leakage in an insert-type inner core structure caused by action of external force. Since a plastic housing is formed through coating on the plastic inner core performed by secondary injection molding, there is no need to manufacture the faucet body in an assembly manner, and, in this manner, the entire structure of the plastic inner core may become stable and reliable. Further, a manufacturing process for forming water tank bodies having different shapes and structures in the plastic inner core by injection molding may be more easily implemented, and there is no need to secondarily process the plastic inner core, thereby reducing the number of processes and lowering production costs.

### BRIEF DESCRIPTION OF THE DRAWINGS

FIG. 1 is a front perspective view of embodiment 1 of the present invention.

FIG. 2 is a perspective view of embodiment 1 of the present invention, as seen from below.

FIG. 3 is a bottom perspective view of embodiment 1 of the present invention.

FIG. 4 is a plan structural view of embodiment 1 of the present invention.

FIG. 5 is a bottom perspective structural view illustrating a plastic inner core of embodiment 1 of the present invention.

FIG. 6 is a bottom structural view illustrating one assembly method of the plastic inner core of embodiment 1 of the present invention.

FIG. 7 is a bottom structural view illustrating another assembly method of the plastic inner core of embodiment 1 of the present invention.

FIG. 8 is a perspective view of embodiment 2 of the present invention, as seen from below.

FIG. 9 is a bottom perspective view of embodiment 2 of the present invention.

FIG. 10 is a structural view illustrating one assembly method of a plastic inner core of embodiment 2 of the present invention.

FIG. 11 is a structural view illustrating another assembly method of the plastic inner core of embodiment 2 of the present invention.

FIG. 12 is a bottom exploded structural view of embodiment 2 of the present invention.

FIG. 13 is a front exploded structural view of embodiment 2 of the present invention.

FIG. 14 is an assembly view illustrating fixing screws and the plastic inner core of embodiment 2 of the present invention during secondary injection coating.

FIG. 15 is a structural view illustrating a mold set and a sealed body of embodiment 2 of the present invention during secondary injection coating.

FIG. 16 is a structural view illustrating the sealed body placed on the lower mold of embodiment 2 of the present invention during secondary injection coating.

FIG. 17 is a structural view illustrating assembly of an upper mold and the lower mold of embodiment 2 of the present invention during secondary injection coating.

FIG. 18 is a cross-sectional structural view of FIG. 17, taken along line A-A.

FIG. 19 is a structural view of embodiment 2 of the present invention after completion of secondary injection coating.

### DETAILED DESCRIPTION

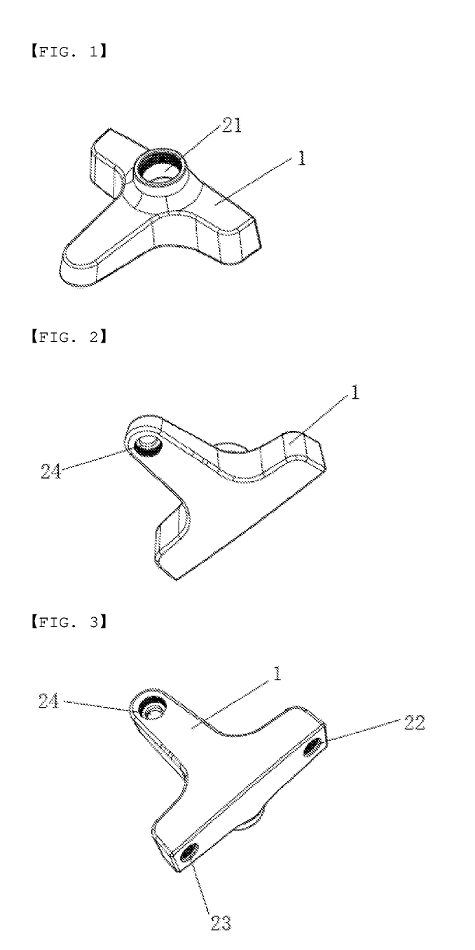

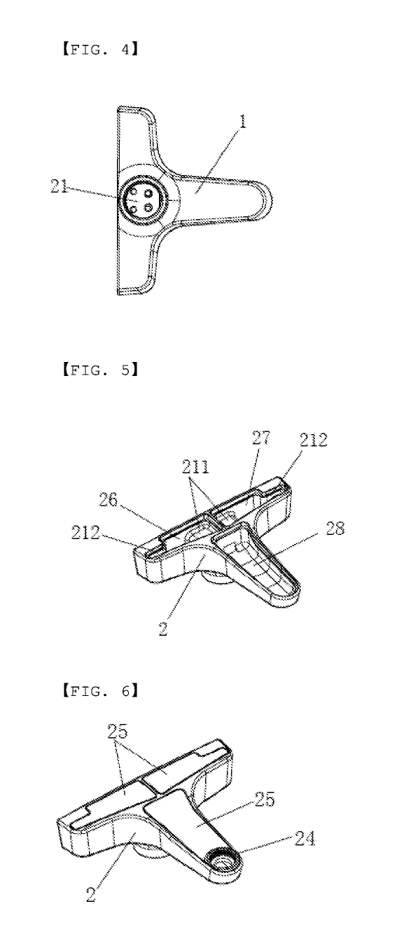

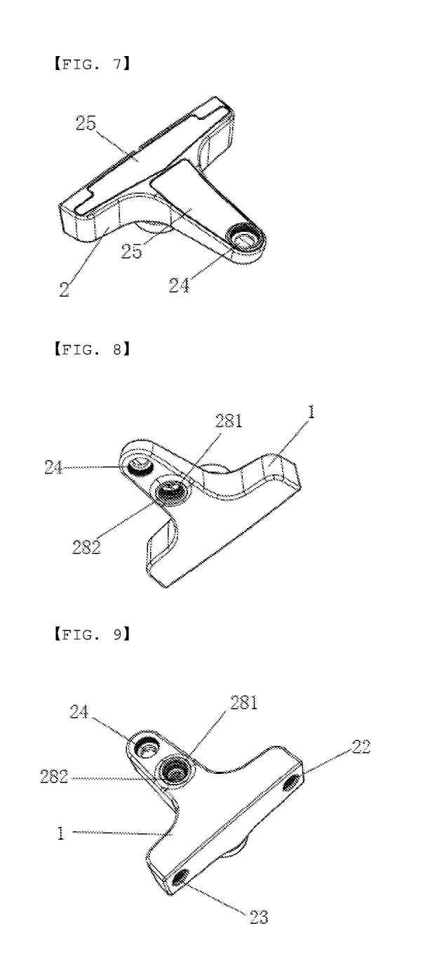

Embodiment 1: Referring to FIGS. 1 to 4, an injection-molded faucet body in accordance with this embodiment is applied to a faucet which discharges cold and warm water, the faucet body includes a plastic housing 1 constituting the outer layer thereof and a plastic inner core 2 constituting the inner layer thereof, the plastic housing 1 and the plastic inner core 2 are integrally formed by injection molding, and the plastic housing 1 and the plastic inner core 2 have a T-shaped structure.

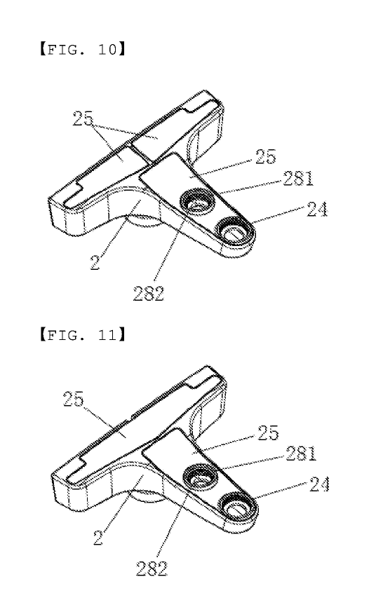

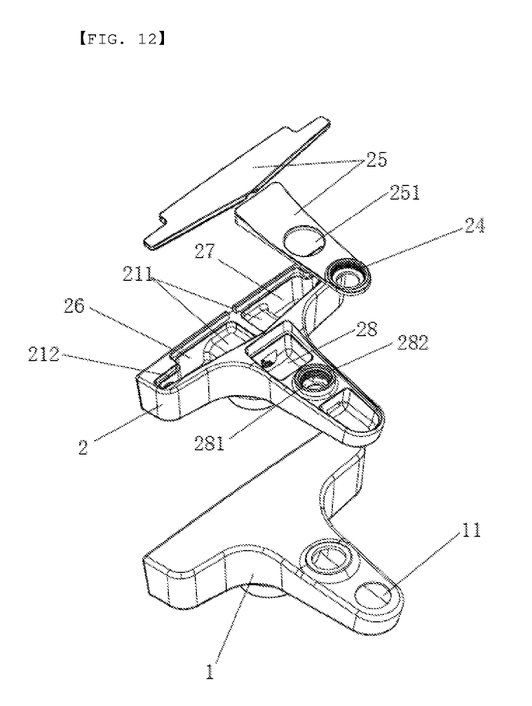

Referring to FIG. 5, in order to solve difficulty in manufacturing a plastic faucet into a curved water pipe or a water pipe having an irregular shape, a valve spool mounting groove 21, a cold water supply opening 22, a warm water supply opening 23, a cold water supply tank 26, a warm water supply tank 27 and a water discharge tank 28 are formed in the plastic inner core 2, i.e., when the plastic inner core 2 is injection-molded, water current paths are replaced with open tank structures, and then sealing cover plates 25 matching respective tank bodies of the cold water supply tank 26, the warm water supply tank 27 and the water discharge tank 28 are installed such that a cold water supply cavity, a warm water supply cavity and a water discharge cavity are formed therein, respectively. Thereamong, a water discharge opening 24 is formed through the sealing cover plate 25 on the water discharge tank 28, and the cold water supply tank 26 and the warm water supply tank 27 may be sealed by two assembly methods, i.e., sealed with independent sealing cover plates 25, as exemplarily shown in FIG. 6, or sealed with one integral sealing cover plate 25, as exemplarily shown in FIG. 7. The cold water supply opening 22 communicates with the valve spool mounting groove 21 through the cold water supply cavity, the warm water supply opening 23 communicates with the valve spool mounting groove 21 through the warm water supply cavity, the valve spool mounting groove 21 communicates with the water discharge opening 24 through the water discharge cavity, open holes communicating with the water discharge cavity are formed at the bottom of the valve spool mounting groove 21, and through holes 11 respectively corresponding to the valve spool mounting groove 21, the cold water supply opening 22, the warm water supply opening 23 and the water discharge opening 24 are formed through the plastic housing 1, after the plastic housing 1 and the plastic inner core 2 are integrally injection-molded. When the faucet body is assembled and used, the valve spool mounting groove 21 serves to mount a valve spool of a faucet therein, a handle is mounted at the valve spool to form the faucet, and the faucet may be applied to a bathtub, a shower head, a washstand, a basin, a washstand and a sink.

In the above structure, a slow current structure and a water supply hole communicating with the valve spool mounting groove 21 are formed in each of the cold water supply tank 26 and the warm water supply tank 27. As exemplarily shown in FIG. 5, in this embodiment, the slow current structure includes a first protrusion 211 installed at the bottom of the tank body and a second protrusion 212 installed at the side wall of the tank body. That is, the first protrusion 211 and the second protrusion 212 are installed in both the cold water supply tank 26 and the warm water supply tank 27, and thereamong, the water supply hole in the cold water supply tank 26 and the water supply hole in the warm water supply tank 27 are formed in on the upper surfaces of the first protrusions 211 and the cold water supply opening 22 and the warm water supply opening 23 are formed in the second protrusions 212. That is, the first protrusions 211 and the second protrusions 212 are installed perpendicularly to each other, and such a structure allows water currents to flow into the corresponding water supply cavities along the cold and warm water supply openings and then change direction and be discharged from the corresponding water supply holes, and is thus advantageous in mitigation of water current shock. Since the first protrusions 211 serve to reduce a flow velocity of the water current and may thus reduce pressure which the water pressure applies to the plastic inner core 2, the water current may be more uniformly discharged from the water supply hole.

The cold water supply tank 26 is formed so as to be gradually widened in a direction from the cold water supply opening 22 to the water supply hole, and the warm water supply tank 27 is formed so as to be gradually widened in a direction from the warm water supply opening 23 to the water supply hole. Thereby, the water current is constantly increased, and a slow current is decompressed and simultaneously does not influence a water discharge quantity from the water supply hole.

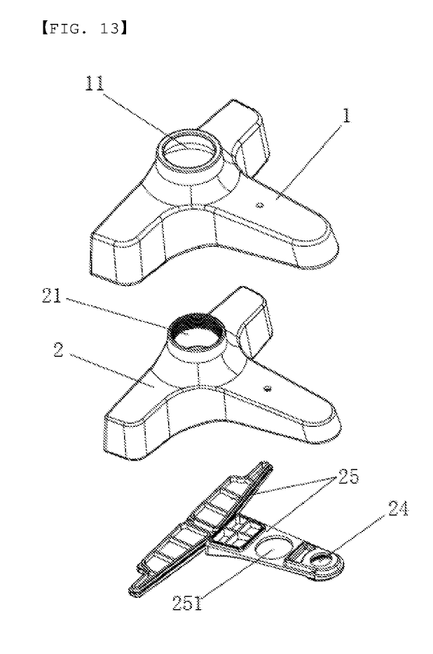

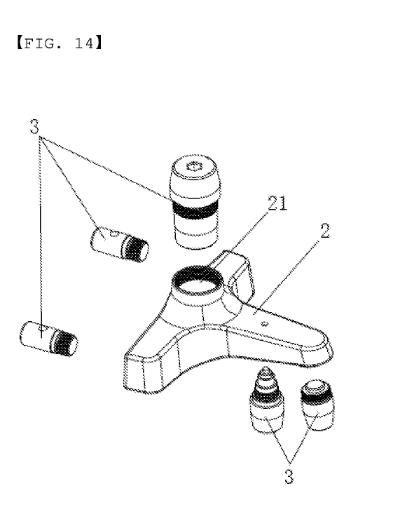

Embodiment 2: Referring to FIGS. 8 and 9, a structure of embodiment 2 is different from that of embodiment 1 in that a water discharge joint 281 to be connected to an external shower head and a grooved hole 282 to mount a change-over switch therein are further formed in a plastic inner core 2, and in more detail, the grooved hole 282 is formed at a middle position of a water discharge tank 28, and two side holes are formed in the grooved hole 282 such that one side hole communicates with a valve spool mounting groove 21 and the other side hole communicates with a water discharge opening 24. In this embodiment, a cold water supply tank 26 and a warm water supply tank 27 may be sealed by two assembly methods, i.e., sealed with independent sealing cover plates 25, as exemplarily shown in FIG. 10, or sealed with one integral sealing cover plate 25, as exemplarily shown in FIG. 11. An opening 251 corresponding to the water discharge joint 281 is formed through a sealing cover plate 25 on the water discharge tank 28, and a through hole 11 corresponding to the water discharge joint 281 is formed through a plastic housing 11, as exemplarily shown in FIGS. 12 and 13. Embodiment 2 may be applied to a shower head faucet, and when a shower head is connected to the water discharge joint 281, water discharge between the water discharge opening 24 and the water discharge joint 281 may be changed through the change-over switch.

The present invention further provides a manufacturing method applied to the faucet body, the manufacturing method including:

(1) forming the plastic inner core 2 to integrally have the valve spool mounting groove 21, the cold water supply opening 22, the warm water supply opening 23, the cold water supply tank 26, the warm water supply tank 27 and the water discharge tank 28, by injection molding;

(2) forming water current paths by covering the cold water supply tank 26, the warm water supply tank 27 and the water discharge tank 28 with the sealing cover plates 25 and forming the water discharge opening 24 through the sealing cover plate 25 on the water discharge tank 28, after formation of the plastic inner core 2 by injection molding;

(3) forming the plastic housing 1 constituting the outer layer of the faucet body through secondary injection coating performed by secondary injection molding of the plastic inner core 2, and thus forming a double plastic faucet body; and

(4) sequentially plating the plastic housing 1 with a copper layer, a nickel layer and a chrome layer, after formation the plastic housing 1 by secondary injection molding, a thickness of the copper layer being about 25 μm, a thickness of the nickel layer being about 5-20 μm and a thickness of the chrome layer being about 0.5 μm.

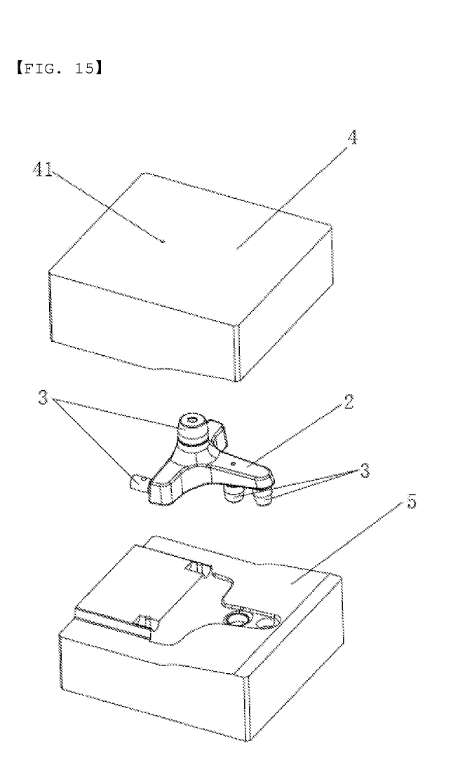

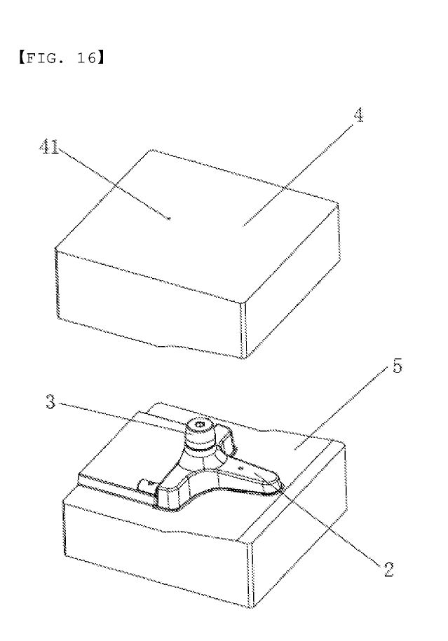

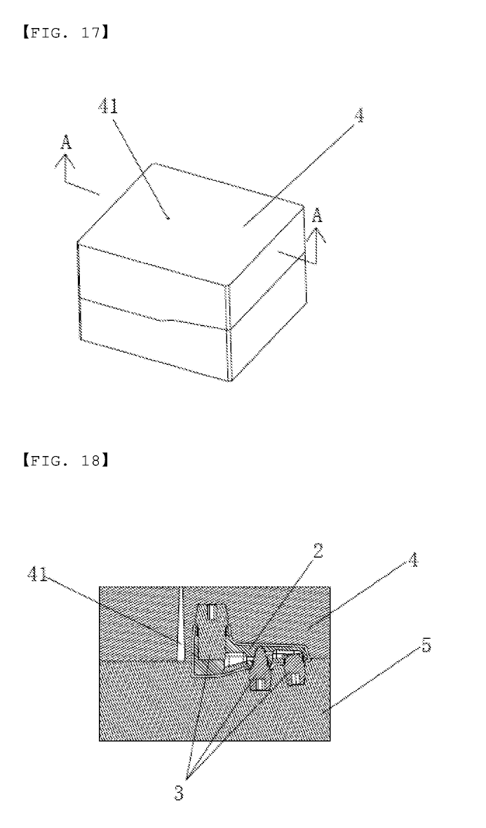

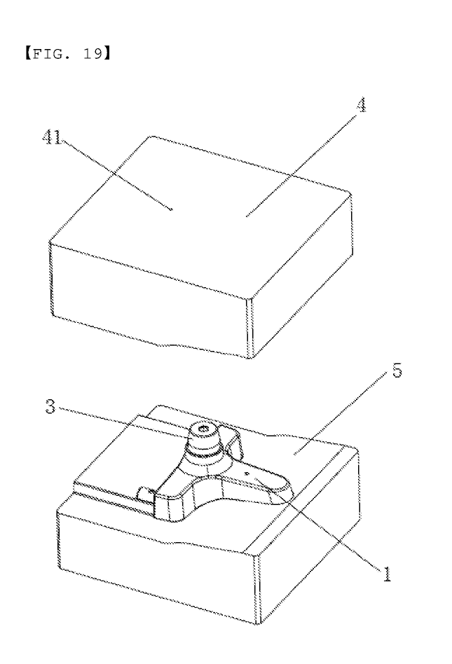

Referring to FIGS. 14 to 19, a process of performing secondary injection coating in formation of the plastic housing 1 (3) will be described below. First, fixing screws 3 are respectively inserted into the cold water supply opening, the warm water supply opening and the water discharge opening of the plastic inner core 2 such that the fixing screws 3 having different sizes corresponding to different diameters of the cold water supply opening, the warm water supply opening and the water discharge opening are coupled to the plastic inner core 2 to form a sealed body, and the plastic housing 1 is formed on the surface of the plastic inner core 2 by performing injection molding under the condition that the sealed body is placed in a plastic mold set. FIGS. 14 to 19 are structural views illustrating the secondary injecting coating process in embodiment 2.

Referring to FIGS. 15 and 16, the used injection mold set includes an upper mold 4 and a lower mold 5, recesses are formed on the upper mold 4 and the lower mold 5, and the recesses of the upper mold 4 and the lower mold 5 are coupled to form an injection cavity. An injection hole 41 communicating with the injection cavity is formed through the upper mold 4, and when injection molding is performed, the sealed body is placed in the recess of the lower mold 5 and then the upper mold 4 is covered thereon. Since there is a gap between the injection cavity and the plastic inner core 2, an injection molding material is injected through the injection hole 41 and fills the gap and, thus, the plastic housing 1 is formed on the surface of the plastic inner core 2.

Such an operation corresponds to a manufacturing process of embodiment 1 , and the structure of embodiment 2 is acquired by additionally forming the water discharge joint to be connected to an external shower head and the grooved hole to mount a change-over switch therein when the plastic inner core 2 is injection-molded. When secondary injection coating is performed, the grooved hole is also sealed by inserting a fixing screw 3 thereinto.

In the above-described operation, the plastic housing 1 and the plastic inner core 2 are formed by injection molding using a mixture of ABS and PC, and herein, a mass percentage of ABS is 20%-90% and a mass percentage of PC is 10%-80%. The plastic housing 1 and the plastic inner core 2 are injection-molded using the same material so that inner and outer plastic members are closely coupled to form an integral structure in the genuine sense and, in this manner, the structure of the faucet body becomes more solid. The faucet body formed by injection molding using a mixture of ABS and PC has a combination of outstanding properties of the two materials, such as formability of ABS and mechanical properties, impact strength, temperature resistance and UV resistance of PC.

Further, ABS+PC has electroplating performance which is higher than that of ABS and surface adhesive force which complies with regulations of a plating layer adhesive strength test on a plastic host body in GB18145-2014 standards. Here, a test medium was air, a faucet was maintained in a temperature environment of (70±2)° C. for 30 minutes and then removed from the environment, was maintained at a temperature of 15° C. for 15 minutes, was maintained in a temperature environment of −30° C. for 30 minutes and then removed from the environment and was maintained at a temperature of 15° C. for 15 minutes, such a process forming one cycle was continuously repeated five cycles, and, as a result, a plating layer formed on the surface of the faucet had no disconnection and did not cause cracks, bubbles, loosening, etc. The surface plating layer underwent an acetate spraying test for 24 hours through GB/T10125-2013 standards and, as a result, may reach grade 9-10 or higher according to GB/6461-2002 standards. ABS+PC has excellent performance and thus has much higher performance than conventional brass and ABS, and a faucet manufactured using ABS+PC will be favorable to healthy living.

In the above-described manufacturing method, the plastic housing 1 is formed by performing secondary injection coating on the plastic inner core 2, and thus, it is unnecessary to manufacture a faucet body in an assembly manner. Therefore, the overall structure of the plastic inner core 2 may be stable and reliable, a manufacturing process for forming tank bodies having different shapes and structures in the plastic inner core 2 may be more easily implemented, and the plastic inner core 2 does not require secondary processing and thus the number of processes may be reduced and production costs may be lowered.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### DESCRIPTION OF MARKS AND REFERENCE NUMERALS

1: plastic housing

2: plastic inner core

11: through hole

21: valve spool mounting groove

22: cold water supply opening

23: warm water supply opening

24: water discharge opening

25: sealing cover plate

26: cold water supply tank

27: warm water supply tank

28: water discharge tank

211: first protrusion

212: second protrusion

25: opening

271: water discharge joint

281: water discharge joint

282: grooved hole

1. An injection-molded faucet body comprising a plastic housing constituting an outer layer thereof and a plastic inner core constituting an inner layer thereof, the plastic housing and the plastic inner core being integrally injection-molded, wherein:
a valve spool mounting groove, a cold water supply opening, a warm water supply opening, a cold water supply tank, a warm water supply tank and a water discharge tank are formed in the plastic inner core, sealing cover plates matching respective tank bodies of the cold water supply tank, the warm water supply tank and the water discharge tank are installed such that a cold water supply cavity, a warm water supply cavity and a water discharge cavity are formed therein, a water discharge opening is formed through the sealing cover plate on the water discharge tank, the cold water supply opening communicates with the valve spool mounting groove through the cold water supply cavity, the warm water supply opening communicates with the valve spool mounting groove through the warm water supply cavity, and the valve spool mounting groove communicates with the water discharge opening through the water discharge cavity; and
a slow current structure and a water supply hole communicating with the valve spool mounting groove are formed in each of the cold water supply tank and the warm water supply tank, the slow current structure comprises a first protrusion installed at a bottom of the tank body, and the water supply hole in the cold water supply tank and the water supply hole in the warm water supply tank are formed in the upper surfaces of the corresponding first protrusions.

2. The injection-molded faucet body according to claim 1, wherein the slow current structure further comprises a second protrusion installed at a side wall of the tank body, and the cold water supply opening and the warm water supply opening are formed in the corresponding second protrusions.

3. The injection-molded faucet body according to claim 1, wherein the tank body of the cold water supply tank is formed so as to be gradually widened in a direction from the cold water supply opening to the water supply hole, and the tank body of the warm water supply tank is formed so as to be gradually widened in a direction from the warm water supply opening to the water supply hole.

4. The injection-molded faucet body according to claim 3, wherein a water discharge joint configured to be connected to an external shower head and a grooved hole configured to mount a change-over switch to change water discharge between the water discharge opening and the water discharge joint are further formed in the plastic inner core, and the grooved hole is located at the water discharge tank.

5. A method for manufacturing an injection-molded faucet body, comprising the steps of:
forming a plastic inner core so as to integrally have a valve spool mounting groove, a cold water supply opening, a warm water supply opening, a cold water supply tank, a warm water supply tank and a water discharge tank, by injection molding;
forming water current paths by covering the cold water supply tank, the warm water supply tank and the water discharge tank with sealing cover plates and forming a water discharge opening through the sealing cover plate on the water discharge tank, after the forming the plastic inner core by injection molding; and
forming a plastic housing constituting the outer layer of the faucet body through secondary injection coating performed by secondary injection molding of the plastic inner core, and thus forming a double plastic faucet body.

6. The method according to claim 5, wherein, in the step of forming the plastic housing, further comprising a process of performing the secondary injection coating comprising:
inserting fixing screws respectively into the cold water supply opening, the warm water supply opening and the water discharge opening of the plastic inner core such that the fixing screws are coupled to the plastic inner core to form a sealed body; and
forming the plastic housing on the surface of the plastic inner core by performing injection molding under the condition that the sealed body is placed in a plastic mold set.

7. The method according to claim 6, wherein, in the forming the plastic inner core by injection molding, a water discharge joint configured to be connected to an external shower head and a grooved hole configured to mount a change-over switch therein are further formed, and, when the secondary injection coating is performed, the grooved hole is sealed by inserting a fixing screw thereinto.

8. The method according to claim 5, further comprising sequentially plating the plastic housing with a copper layer, a nickel layer and a chrome layer, after the forming the plastic housing by secondary injection molding.

9. The method according to claim 8, wherein the plastic housing and the plastic inner core are formed by injection molding using a mixture of ABS and PC, a mass percentage of the ABS is 20%-90% and a mass percentage of the PC is 10%-80%.
